(19) United States
(12) Patent Application Publication
(10) Pub. No.: US 2003/0182546 A1
(43) Pub. Date: Sep. 25, 2003

(54) Information device, storage medium, and system activation method

(75) Inventors: Yasuyuki Suzuki, Fussa-shi (JP); Akira Kumagai, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/325,970

(22) Filed: Dec. 23, 2002

(30) Foreign Application Priority Data
Mar. 22, 2002 (JP) 2002-081916

(51) Int. Cl. G06F 9/00; G06F 9/24

(52) U.S. Cl. 713/1

(57) ABSTRACT

A desired one of a plurality of systems is easily activated. When a user powers on an information device main body while pressing, e.g., the “4” key on a keyboard, an activated BIOS detects both that the device is powered on and that the “4” key is pressed and activates a switching program. The activated switching program stores setting contents for activating the system from the fourth partition (changing the fourth partition to the active partition) in the partition table of a boot block and then activates the boot block. Since the partition table indicates that the system is to be activated from the fourth partition, the activated boot block activates the system from the fourth partition.

### CROSS-REFERENCE TO RELATED APPLICATIONS

This application is based upon and claims the benefit of priority from the prior Japanese Patent Application No. 2002-081916, filed Mar. 22, 2002, the entire contents of which are incorporated herein by reference.

### BACKGROUND OF THE INVENTION

1. Field of the Invention

The present invention relates to a system activation method of selectively activating a plurality of systems stored in the storage medium of an information device, the information device, and the storage medium.

2. Description of the Related Art

In an information device such as a personal computer, sometimes, a plurality of partitions are formed on its internal storage medium (e.g., a hard disk drive), and a system (e.g., an OS) is installed in each partition. In this case, the user of the information device must selectively use the plurality of installed systems in accordance with the application purpose.

Generally, a partition (active partition) from which the system is to be activated is fixed. To switch the active partition, a separately prepared dedicated tool must be used. To use the tool, a certain system (e.g., an OS) must temporarily be activated.

After a system is activated to use the tool, a command called FDISK or a disk administrator is executed to change the active partition.

However, every time the user wants to switch the system to be activated, operation for switching the active partition must be performed using the dedicated tool.

For the active partition switching operation, the certain system must temporarily be activated. In addition, predetermined operation must be done. Hence, the user feels the procedure very cumbersome. A user who is inexperienced in usage of the tool may readily suffer operation errors and waste of time.

The switching method using a dedicated tool cannot sufficiently cope with a case wherein expeditious activation of a desired system is required or the system to be activated must be frequently switched. That is, operation that satisfies the user to some extent cannot be realized.

### BRIEF SUMMARY OF THE INVENTION

Embodiments of the present invention provide an information device, storage medium, and system activation method capable of easily activating a desired one of a plurality of systems.

According to one aspect of the present invention, there is provided a storage medium which stores information, the information comprising a plurality of systems arranged in a plurality of partitions; a boot block which activates a system from one of the partitions; and an activation partition switching program which indicates, to the boot block, one of the partitions, from which the system is to be activated.

According to another aspect of the present invention, there is provided an information device comprising a storage medium which stores a plurality of systems arranged in a plurality of partitions, a boot block which activates a system from one of the partitions, and an activation partition switching program which indicates, to the boot block, one of the partitions, from which the system is to be activated; and a basic input/output system capable of, upon detecting a predetermined operation, activating the activation partition switching program and notifying the activation partition switching program of information representing that the system is to be activated from a partition corresponding to the predetermined operation, wherein when activated by the basic input/output system, the activation partition switching program indicates, to the boot block, that the system is to be activated from the partition represented by the information sent from the basic input/output system.

According to still another aspect of the present invention, there is provided a system activation method of selectively activating a plurality of systems stored in a storage medium of an information device, comprising arranging the systems in a plurality of partitions on the storage medium; arranging, in a predetermined area on the storage medium, a boot block which activates a system from one of the partitions; arranging, in a predetermined area on the storage medium, an activation partition switching program which indicates, to the boot block, one of the partitions, from which the system is to be activated; upon detecting a predetermined operation, causing a basic input/output system to activate the activation partition switching program and notify the activation partition switching program of information representing that the system is to be activated from a partition corresponding to the predetermined operation; and causing the activation partition switching program activated by the basic input/output system to indicate, to the boot block, that the system is to be activated from the partition represented by the information sent from the basic input/output system.

Additional embodiments and advantages of the invention will be set forth in the description which follows, and in part will be obvious from the description, or may be learned by practice of the invention. The embodiments and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the arrangement of an information device according to an embodiment of the present invention;

FIG. 2 is a view for explaining the relationship between a BIOS and hard disk used in the information device shown in FIG. 1;

FIG. 3 is a view for explaining the recording positions, on the hard disk, of a boot block (MBR) and switching programs shown in FIG. 2;

FIG. 4 is a view for explaining the arrangement of a partition table prepared in the boot block (MBR) shown in FIGS. 2 and 3;

FIG. 5 is a flow chart for explaining operation by the embodiment; and

FIG. 6 is a view for explaining a modification of the arrangement shown in FIG. 2.

### DETAILED DESCRIPTION OF THE INVENTION

Embodiments of the present invention will be described below with reference to the accompanying drawing.

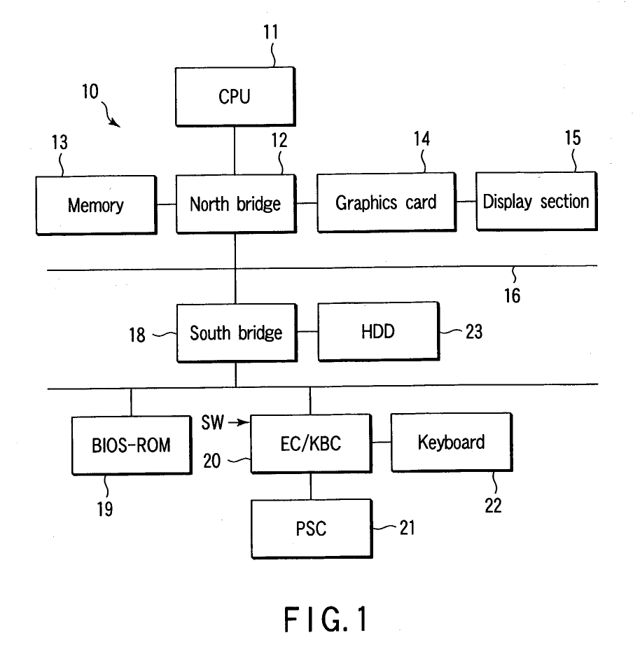

FIG. 1 is a block diagram showing the arrangement of an information device according to an embodiment of the present invention.

An information device 10 is implemented as, e.g., a portable personal computer. The information device 10 has a CPU (Central Processing Unit) 11, north bridge 12, memory 13, graphics card 14, display section 15, PCI (Peripheral Component Interconnect) bus 16, south bridge 18, BIOS-ROM (Basic Input/Output System—Read Only Memory) 19, EC/KBC (Embedded Controller/KeyBoard Controller) 20, PSC (Power Supply Controller) 21, keyboard 22, HDD (Hard Disk Drive) 23, and the like.

The CPU 11 controls the operation of the entire information device 10. For example, the CPU 11 executes data processing with respect to another device in the information device 10 and executes various kinds of programs.

The north bridge 12 has various kinds of controllers that execute bridge processing between the CPU 11 and the south bridge 18, control of the memory 13, control of the graphics card 14, and the like.

The memory 13 is provided as the work area of the CPU 11. During operation of the information device 10, an OS (Operating System) and various kinds of application programs are loaded to the memory 13 and run under the control of the CPU 11.

The graphics card 14 is connected to the north bridge 12 through an AGP (Accelerated Graphics Port) to control data that is to be displayed on the display section 15.

The display section 15 corresponding to a display unit displays various kinds of information in accordance with signals sent from the graphics card 14.

The PCI bus 16 is inserted between the north bridge 12 and the south bridge 18. A plurality of PCI devices can be connected to the PCI bus 16.

The south bridge 18 is connected to the north bridge 12 through the PCI bus 16. The south bridge 18 is also connected to the BIOS-ROM 19 and EC/KBC 20 through an LPC bus and the like. The south bridge 18 has various kinds of controllers to control the individual devices. The south bridge 18 also has an IDE controller that controls the HDD 23 connected through an IDE (Integrated Device Electronics) connector.

The BIOS-ROM 19 stores a BIOS that mainly executes control related to hardware at the time of activating the information device 10. The BIOS of this embodiment incorporates a logic that detects, through the EC/KBC 20, whether the information device (main body) 10 is powered on (the power switch is turned on), and simultaneously, a specific key (e.g., a number key) on the keyboard 22 is pressed. The subsequent processing procedure changes depending on the detection result. This processing procedure will be described later.

The EC/KBC 20 is formed by integrating an EC serving as an embedded controller and a keyboard controller (KBC). The embedded controller (EC) outputs a power ON/OFF instruction to the power supply controller (PSC) 21 in accordance with the power supply state of the information device (main body) 10 (e.g., the ON/OFF state of a power switch SW). The keyboard controller (KBC) controls the keyboard 22 connected to it.

The power supply controller (PSC) 21 ON/OFF-controls power supply necessary for each element in the information device 10 in accordance with the instruction from the embedded controller (EC).

The keyboard 22 is connected to the keyboard controller (KBC) in the EC/KBC 20 and used by the user to execute key input operation.

The HDD 23 incorporates a hard disk serving as a magnetic recording medium. The HDD 23 is connected to the south bridge 18 through an IDE connector.

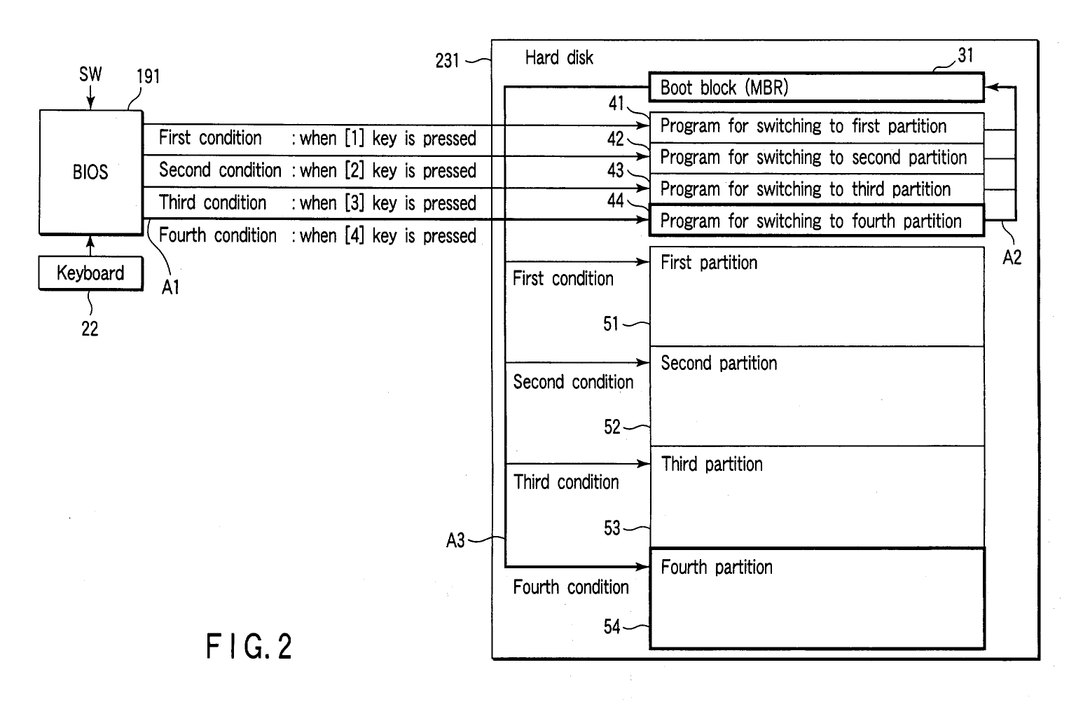

FIG. 2 is a view for explaining the relationship between a BIOS and hard disk used in the information device shown in FIG. 1.

A hard disk 231 is a magnetic recording medium incorporated in the above-described HDD 23. A boot block 31 called a master boot record (MBR) and activation partition switching programs (to be simply referred to as “switching programs” hereinafter) 41 to 44 arranged in correspondence with first to forth partitions 51 to 54 are stored in the hard disk 231. The first to fourth partitions 51 to 54 that save various kinds of systems (OSs) are provided on the recording surface of the hard disk 231.

The boot block 31 has a function of, when invoked (activated) from one of the switching programs 41 to 44, recognizing an active partition (one of the first to fourth partitions 51 to 54) by looking up a partition table (to be described later) in itself, and activating the system from the active partition.

The switching program 41 has a function of, when invoked (activated) from a BIOS 191, executing setting processing for activating the system from the first partition 51 on the partition table of the boot block 31 and then invoking (activating) the boot block 31.

Similarly, the switching program 42 has a function of, when invoked (activated) from the BIOS 191, executing setting processing for activating the system from the second partition 52 on the partition table of the boot block 31 and then invoking (activating) the boot block 31.

The switching program 43 also has a function of, when invoked (activated) from the BIOS 191, executing setting processing for activating the system from the third partition 53 on the partition table of the boot block 31 and then invoking (activating) the boot block 31.

Similarly, the switching program 44 has a function of, when invoked (activated) from the BIOS 191, executing setting processing for activating the system from the fourth partition 54 on the partition table of the boot block 31 and then invoking (activating) the boot block 31.

On the other hand, the BIOS 191 is a BIOS stored in the above-described BIOS-ROM 19. Upon detecting that the information device (main body) 10 is powered on (the power switch is turned on), and simultaneously, a specific key (in this case, one of the number keys “1”, “2”, “3”, and “4”) on the keyboard 22 is pressed, the BIOS 191 invokes (activates) a corresponding one of the switching programs 41 to 44.

The flow of processing for activating the system will be described here with reference to FIG. 2.

For example, at the time of powering on, the user presses the “4” key as the specific key on the keyboard 22 to activate the system of the fourth partition 54.

A1: When the user powers on the information device (main body) 10 while pressing the “4” key on the keyboard 22 to activate the system of the fourth partition 54, the BIOS 191 is activated. At this time, the BIOS 191 detects both that the device is powered on and that the “4” key is pressed. Upon detecting that the “4” key is pressed, the BIOS 191 executes setting processing related to the hardware and then generates a predetermined signal to activate the switching program 44.

A2: The switching program 44 activated by the BIOS 191 stores setting contents for activating the system from the fourth partition 54 (changing the fourth partition 54 to the active partition) in the partition table of the boot block 31 and then activates the boot block 31.

A3: Since the partition table indicates that the system is to be activated from the fourth partition 54, the boot block 31 activated by the switching program 44 activates the system from the fourth partition 54.

In this way, when the user powers on the information device (main body) 10 while pressing the “4” key on the keyboard 22, setting is done by the switching program 44 to change the fourth partition 54 to the active partition. Then, the system is activated from the fourth partition 54.

When the user powers on the information device (main body) 10 while pressing the “1” key on the keyboard 22, setting is done by the switching program 41 to change the first partition 51 to the active partition. Then, the system is activated from the first partition 51.

Simultaneously, when the user powers on the information device (main body) 10 while pressing the “2” key on the keyboard 22, setting is done by the switching program 42 to change the second partition 52 to the active partition. Then, the system is activated from the second partition 52.

Simultaneously, when the user powers on the information device (main body) 10 while pressing the “3” key on the keyboard 22, setting is done by the switching program 43 to change the third partition 53 to the active partition. Then, the system is activated from the third partition 53.

When the system activated from a partition is to end its operation, the setting contents on the partition table of the boot block 31 are changed such that the corresponding partition returns to an inactive partition.

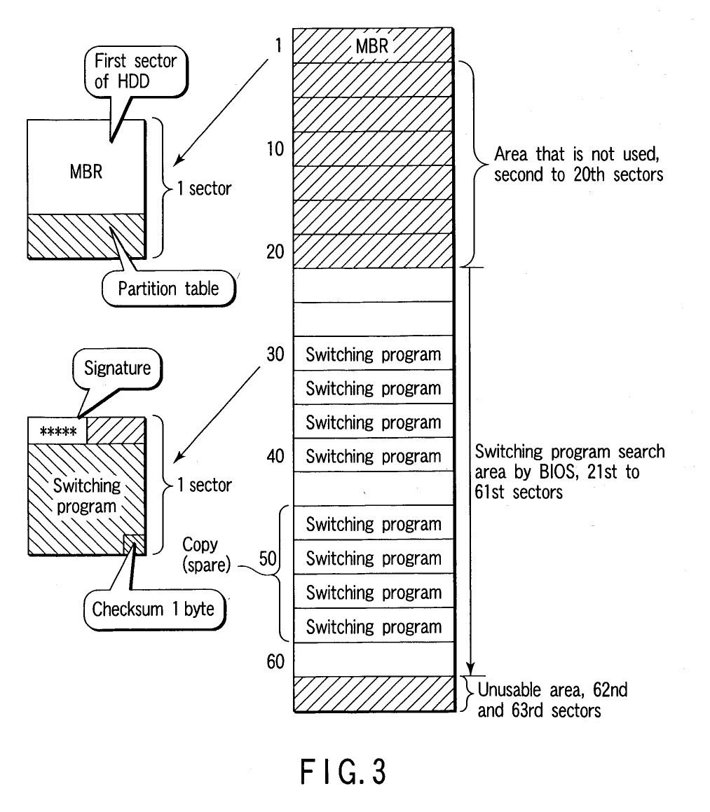

FIG. 3 is a view for explaining the recording positions, on the hard disk, of the boot block (MBR) 31 and switching programs 41 to 44 shown in FIG. 2.

As shown in FIG. 3, the MBR (boot block) is recorded in the first sector (one sector) on the hard disk. The MBR on the first sector is accessed from the BIOS or each switching program. The MBR has the partition table.

A plurality of switching programs (one switching program for one sector) are recorded in, e.g., the 21st to 61st sectors, including spare programs. In activating the system, the BIOS searches for a necessary switching program sequentially from the 21st sector. When the target switching program is properly detected, the switching program is activated. Each switching program has a signature indicating its source or a checksum (one byte) for error detection, as needed.

The sector (first sector) at which the MBR is recorded is an area that cannot be used for any other purpose. For this reason, no switching program can be recorded in this area. The second to 20th sectors are areas that may be used as a work area for updating processing of the operating system. If a switching program is recorded in this area, the switching program may be erased when another data is overwritten. Hence, no switching program is recorded in this area.

A plurality of switching programs including spares are recorded, as shown in FIG. 3. In this case, even when the target switching program becomes undetectable due to some reason, a spare (copy) switching program can be detected, and processing can be normally executed. Hence, the reliability of system activation processing can be increased.

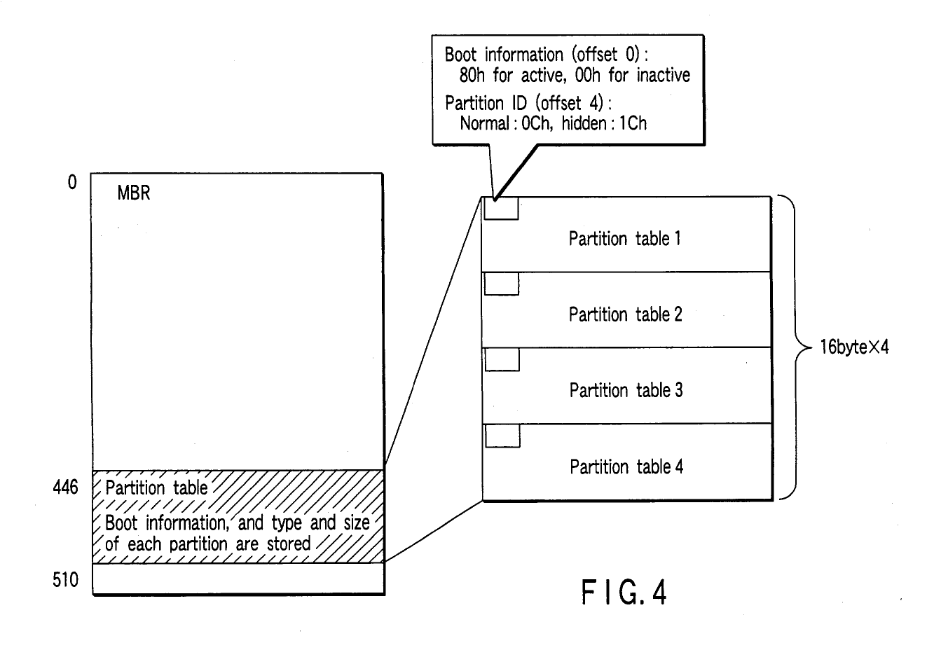

FIG. 4 is a view for explaining the arrangement of the partition table prepared in the boot block (MBR) shown in FIGS. 2 and 3.

As shown in FIG. 3, the MBR has, for each partition, a table containing boot information (active/inactive) related to four partition tables 1 to 4 prepared on the hard disk and information such as the ID or type of each partition (normal partition/hidden partition) and the size of each partition. As boot information, for example, “80 h” is set for an active partition and “00 h” for an inactive partition.

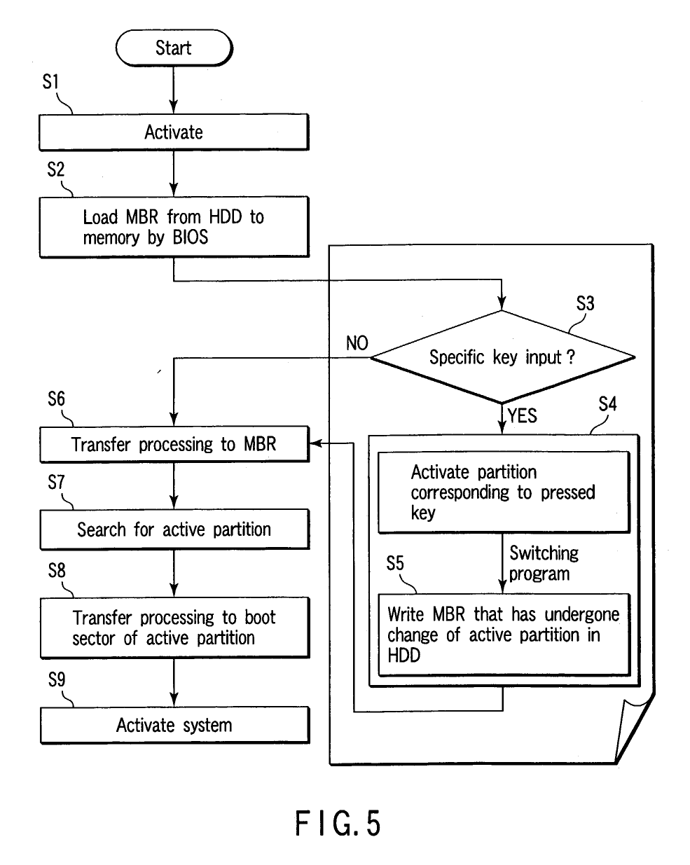

The operation of this embodiment will be described next with reference to the flow chart shown in FIG. 5.

When the information device (main body) 10 is powered on, the BIOS 191 is activated (step S1). At this time, if a specific key (one of the “1”, “2”, “3”, and “4” keys) is pressed, the BIOS 191 detects it.

The BIOS 191 loads the boot block (MBR) 31 from the HDD 23 onto the memory (step S2) and executes the following procedure before transferring the processing to the boot block 31.

The BIOS 191 determines whether a specific key (one of the “1”, “2”, “3”, and “4” keys) is input at the time of power-on (step S3). If YES in step S3, the BIOS 191 activates a switching program (one of the switching programs 41 to 44) corresponding to the specific key.

The activated switching program executes, on the partition table of the boot block 31, setting for changing a partition corresponding to the pressed key (a corresponding one of the first to fourth partitions 51 to 54) to the active partition (and setting for changing the remaining partitions to inactive partition) (step S4). The boot block 31 that has undergone change of the active partition is written in the HDD (step S5). Control is transferred from the switching program to the boot block 31 (step S6).

If NO in step S3, control is transferred from the BIOS 191 to the boot block 31.

The boot block 31 searches the partition table for the active partition (step S7) and transfers the processing to the boot sector of the active partition detected by the search (step S8). Accordingly, the system on the active partition is activated from the boot sector (step S9).

According to this operation, the user feels as if the necessary active partition were already set in activating the system.

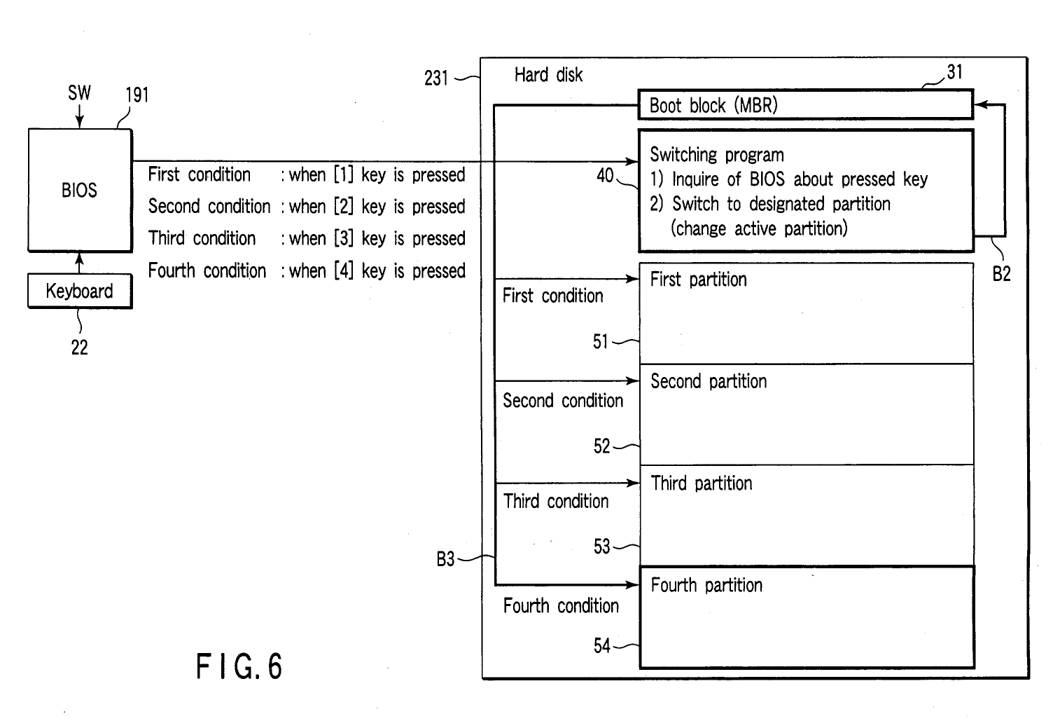

A modification of the arrangement shown in FIG. 2 will be described next with reference to FIG. 6. The same reference numerals as in FIG. 2 denote the same elements in FIG. 6, and a detailed description thereof will be omitted.

In FIG. 2, the number of switching programs 41 to 44 on the hard disk 231 equals the number of partitions. Referring to FIG. 6, instead, a single switching program 40 is prepared. The switching program 40 also has a function of, when invoked from the BIOS 191, inquiring of the BIOS 191 about the partition from which the system is to be activated, and acquiring an answer from the BIOS 191. Accordingly, the same function as that of the switching programs 41 to 44 is implemented.

Upon detecting that the information device (main body) 10 is powered on (the power switch is turned on), and simultaneously, a specific key (in this case, one of the number keys “1”, “2”, “3”, and “4”) on the keyboard 22 is pressed, the BIOS 191 invokes (activates) the switching program 40 and, in response to the inquiry for the switching program 40, notifies the switching program 40 of the partition from which the system is to be activated. This notification is done by sending information representing the number of the pressed key.

The flow of processing for activating the system will be described here with reference to FIG. 6.

In this example as well, assume that at the time of powering on, the user presses the “4” key as the specific key on the keyboard 22 to activate the system of the fourth partition 54.

B1: When the user powers on the information device (main body) 10 while pressing the “4” key on the keyboard 22 to activate the system of the fourth partition 54, the BIOS 191 is activated. At this time, the BIOS 191 detects both that the device is powered on and that the “4” key is pressed. Upon detecting that the “4” key is pressed, the BIOS 191 executes setting processing related to the hardware and then generates a predetermined signal to activate the switching program 40.

B2: The switching program 40 activated by the BIOS 191 1) inquires of the BIOS 191 about the pressed key, 2) stores setting contents for activating the system from the fourth partition 54 (changing the fourth partition 54 to the active partition) corresponding to the “4” key sent from the BIOS 191 in response to the inquiry in the partition table of the boot block 31 and then activates the boot block 31.

B3: Since the partition table indicates that the system is to be activated from the fourth partition 54, the boot block 31 activated by the switching program 40 activates the system from the fourth partition 54.

In this way, when the user powers on the information device (main body) 10 while pressing the “4” key on the keyboard 22, setting is done by the switching program 40 to change the fourth partition 54 to the active partition. Then, the system is activated from the fourth partition 54.

Even when the user powers on the information device (main body) 10 while pressing the “1”, “2”, or “3” key on the keyboard 22, the switching program 40 executes setting to change a corresponding partition (one of the first to third partitions) to the active partition. Then, the system is activated from the partition.

The operation of the modification shown in FIG. 6 is similar to that of the above-described flow chart shown in FIG. 5.

In step S3, the BIOS 191 determines whether a specific key (one of the “1”, “2”, “3”, and “4”keys) is input at the time of power-on. If YES in step S3, the BIOS 191 activates the switching program 40.

In step S4, the activated switching program 40 “inquires of the BIOS 191 about the pressed key and receives an answer”, and then executes, on the partition table of the boot block 31, setting for changing a partition corresponding to the pressed key (one of the first to fourth partitions 51 to 54) to the active partition (and setting for changing the remaining partitions to inactive partition).

When the above modification is employed, multi-boot processing can be realized by the single switching program. In this case, the storage area (FIG. 3) on the hard disk used for the switching program can be saved. In addition, the storage area used for the switching program can be small. Even when a copy switching program is prepared as a spare, the storage area still remains. Furthermore, there is no pressure on other areas. Even when the user wants to install a new system in an unoccupied partition, the procedure is relatively simple because no switching program need be separately prepared on the hard disk in correspondence with the system.

As described above, according to the above embodiment, a multi-boot system can be implemented in which the active partition is automatically switched only by pressing a key corresponding to a system to be activated (or a partition to be changed to the active partition) at the time of power-on, and the desired system is immediately activated.

According to this multi-boot system, the user need not switch the active partition using a dedicated tool and therefore feels no cumbersomeness of the procedure. Additionally, since the desired system can easily be activated only by pressing a specific key at the time of powering on, the user need not have special knowledge for active partition switching operation.

Furthermore, the multi-boot system can sufficiently cope with a case wherein expeditious activation of a desired system is required or the system to be activated must be frequently switched. Hence, operation that satisfies the user to some extent can be realized.

The present invention is not limited to the above-described embodiment, and various changes and modifications can be made within the scope of the invention.

For example, a personal computer has been exemplified in the above embodiment. However, the present invention is not limited to this. The present invention can also be applied to a PDA (Personal Digital Assistant), cellular phone, PHS (Personal Handyphone System), or the like, which has a plurality of systems (e.g., OSs).

As has been described above in detail, according to the present invention, an information device, storage medium, and system activation method capable of easily activating a desired one of a plurality of systems are provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A storage medium which stores information, the information comprising:
a plurality of systems arranged in a plurality of partitions;
a boot block which activates a system from one of the partitions; and
an activation partition switching program which indicates, to the boot block, one of the partitions, from which the system is to be activated.

2. The storage medium according to claim 1, wherein when activated from an external device, the activation partition switching program indicates, to the boot block, that the system is to be activated from a partition represented by information sent from the external device.

3. The storage medium according to claim 1, wherein the activation partition switching program changes setting information to be used by the boot block so as to change the partition from which the system is to be activated to an active partition.

4. The storage medium according to claim 1, wherein a plurality of activation partition switching programs are arranged in correspondence with the partitions so as to selectively indicate, to the boot block, one of the partitions, from which the system is to be activated.

5. The storage medium according to claim 4, wherein when activated from an external device, each of the activation partition switching programs indicates, to the boot block, that the system is to be activated from a partition corresponding to the activation partition switching program.

6. The storage medium according to claim 4, wherein each of the activation partition switching programs changes setting information to be used by the boot block so as to change the partition corresponding to the activation partition switching program to an active partition.

7. An information device comprising:
a storage medium which stores a plurality of systems arranged in a plurality of partitions, a boot block which activates a system from one of the partitions, and an activation partition switching program which indicates, to the boot block, one of the partitions, from which the system is to be activated; and
a basic input/output system capable of, upon detecting a predetermined operation, activating the activation partition switching program and notifying the activation partition switching program of information representing that the system is to be activated from a partition corresponding to the predetermined operation,
wherein when activated by the basic input/output system, the activation partition switching program indicates, to the boot block, that the system is to be activated from the partition represented by the information sent from the basic input/output system.

8. The information device according to claim 7, wherein the activation partition switching program changes setting information to be used by the boot block so as to change the partition from which the system is to be activated to an active partition.

9. The information device according to claim 7, wherein a plurality of activation partition switching programs are arranged in correspondence with the partitions so as to selectively indicate, to the boot block, one of the partitions, from which the system is to be activated.

10. The information device according to claim 9, wherein each of the activation partition switching programs changes setting information to be used by the boot block so as to change the partition corresponding to the activation partition switching program to an active partition.

11. A system activation method of selectively activating a plurality of systems stored in a storage medium of an information device, comprising:
arranging the systems in a plurality of partitions on the storage medium;
arranging, in a predetermined area on the storage medium, a boot block which activates a system from one of the partitions;
arranging, in a predetermined area on the storage medium, an activation partition switching program which indicates, to the boot block, one of the partitions, from which the system is to be activated;
upon detecting a predetermined operation, causing a basic input/output system to activate the activation partition switching program and notify the activation partition switching program of information representing that the system is to be activated from a partition corresponding to the predetermined operation; and
causing the activation partition switching program activated by the basic input/output system to indicate, to the boot block, that the system is to be activated from the partition represented by the information sent from the basic input/output system.

12. The method according to claim 11, wherein setting information to be used by the boot block is changed to change the partition from which the system is to be activated to an active partition.

13. The method according to claim 11, wherein a plurality of activation partition switching programs are arranged in correspondence with the partitions so as to selectively indicate, to the boot block, one of the partitions, from which the system is to be activated.
